(19) United States
(12) Patent Application Publication
(10) Pub. No.: US 2008/0247088 A1
(43) Pub. Date: Oct. 9, 2008

(54) Micro-actuator having at least one segmented flexible side arm, and method of making the same

(75) Inventors: MingGao Yao, Dongguan (CN); Lin Guo, Dongguan (CN); Yu Sun, Dongguan (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 11/730,997

(22) Filed: Apr. 5, 2007

(51) Int. Cl. G11B 5/48

(52) U.S. Cl. 360/234.6; 360/245

(57) ABSTRACT

Certain example embodiments described herein relate to a micro-actuator for use with an HGA and/or disk drive device. A substantially U-shaped frame may include a cavity capable of receiving a slider. The frame may include two segmented, flexible side arms and a bottom support arm at least partially defining the cavity. Each segmented side arm may have a PZT element mounted on an outer surface thereof facing away from the cavity, and each may include a lower portion proximate to the bottom support arm and an upper portion disposed at an end opposing the bottom support arm. The lower portion and the upper portion may be at least partially separated by a gap. Accordingly, micro-actuators having better resonance and servo performance, reduced difficulties associated with the slider/micro-actuator mounting process, and/or better shock performance may be provided.

### FIELD OF THE INVENTION

The example embodiments herein relate to information recording disk drive devices and, more particularly, to a micro-actuator for use with an HGA and/or disk drive device with the micro-actuator having segmented flexible side arms and/or having a reduced gap between the slider and suspension tongue, and/or methods of making the same.

### BACKGROUND OF THE INVENTION

One known type of information storage device is a disk drive device that uses magnetic media to store data and a movable read/write head that is positioned over the media to selectively read from or write to the disk.

Consumers are constantly desiring greater storage capacity for such disk drive devices, as well as faster and more accurate reading and writing operations. Thus, disk drive manufacturers have continued to develop higher capacity disk drives by, for example, increasing the density of the information tracks on the disks by using a narrower track width and/or a narrower track pitch. However, each increase in track density requires that the disk drive device have a corresponding increase in the positional control of the read/write head in order to enable quick and accurate reading and writing operations using the higher density disks. As track density increases, it becomes more and more difficult using known technology to quickly and accurately position the read/write head over the desired information tracks on the storage media. Thus, disk drive manufacturers are constantly seeking ways to improve the positional control of the read/write head in order to take advantage of the continual increases in track density.

One approach that has been effectively used by disk drive manufacturers to improve the positional control of read/write heads for higher density disks is to employ a secondary actuator, known as a micro-actuator, that works in conjunction with a primary actuator to enable quick and accurate positional control for the read/write head. Disk drives that incorporate micro-actuators are known as dual-stage actuator systems.

Various dual-stage actuator systems have been developed in the past for the purpose of increasing the access speed and fine tuning the position of the read/write head over the desired tracks on high density storage media. Such dual-stage actuator systems typically include a primary voice-coil motor (VCM) actuator and a secondary micro-actuator, such as a PZT element micro-actuator. The VCM actuator is controlled by a servo control system that rotates the actuator arm that supports the read/write head to position the read/write head over the desired information track on the storage media. The PZT element micro-actuator is used in conjunction with the VCM actuator for the purpose of increasing the positioning access speed and fine tuning the exact position of the read/write head over the desired track. Thus, the VCM actuator makes larger adjustments to the position of the read/write head, while the PZT element micro-actuator makes smaller adjustments that fine tune the position of the read/write head relative to the storage media. In conjunction, the VCM actuator and the PZT element micro-actuator enable information to be efficiently and accurately written to and read from high density storage media.

One known type of micro-actuator incorporates PZT elements for causing fine positional adjustments of the read/write head. Such PZT micro-actuators include associated electronics that are operable to excite the PZT elements on the micro-actuator to selectively cause expansion and/or contraction thereof. The PZT micro-actuator is configured such that expansion and/or contraction of the PZT elements causes movement of the micro-actuator which, in turn, causes movement of the read/write head. This movement is used to make faster and finer adjustments to the position of the read/write head, as compared to a disk drive unit that uses only a VCM actuator. Exemplary PZT micro-actuators are disclosed in, for example, JP 2002-133803; U.S. Pat. Nos. 6,671,131 and 6,700,749; and U.S. Publication No. 2003/0168935, the contents of each of which are incorporated herein by reference.

FIG. 1 illustrates a conventional disk drive unit and shows a magnetic disk 101 mounted on a spindle motor 102 for spinning the disk 101. A voice coil motor arm 104 carries a head gimbal assembly (HGA) that includes a micro-actuator with a slider 103 incorporating a read/write head. A voice-coil motor (VCM) is provided for controlling the motion of the motor arm 104 and, in turn, controlling the slider 103 to move from track to track across the surface of the disk 101, thereby enabling the read/write head to read data from or write data to the disk 101.

Because of the inherent tolerances (e.g., dynamic play) of the VCM and the head suspension assembly, the slider cannot achieve quick and fine position control, which adversely impacts the ability of the read/write head to accurately read data from and write data to the disk when only a servo motor system is used. As a result, a PZT micro-actuator, as described above, is provided in order to improve the positional control of the slider 103 and the read/write head. More particularly, the PZT micro-actuator corrects the displacement of the slider on a much smaller scale, as compared to the VCM, in order to compensate for the resonance tolerance of the VCM and/or head suspension assembly. The micro-actuator enables, for example, the use of a smaller recording track pitch, and can increase the “tracks-per-inch” (TPI) value for the disk drive unit, as well as provide an advantageous reduction in the head seeking and settling time. Thus, the PZT micro-actuator enables the disk drive device to have a significant increase in the surface recording density of the information storage disks used therein.

FIG. 2a is a partial perspective view of an HGA 277 having a conventionally designed micro-actuator, FIG. 2b is a partial perspective view of the tongue region of the HGA of FIG. 2a, and FIG. 2c illustrates how a slider and micro-actuator conventionally are mounted to each other. With respect to FIGS. 2a-c, a conventional PZT micro-actuator 205 comprises a ceramic U-shaped frame 297. The frame 297 comprises two ceramic beams 207, each of which has a PZT element (not labeled) mounted thereon for actuation. The PZT micro-actuator 205 is operably coupled to a suspension 213, and there are multiple (e.g., three) electrical connection balls 209 (formed by, for example, gold ball bonding (GBB) or solder ball bonding (SBB)) to operably couple the micro-actuator 205 to the suspension traces 210 on one side of each of ceramic beam 207. In addition, there are multiple (e.g., four) metal balls 208 (formed by, for example, GBB or SBB) to operably couple the slider 203 to the suspension traces 210 for connection with read/write transducers (not shown). The micro-actuator 205 is mounted to the suspension tongue by the bottom arm of the frame 297, and the slider 203 is at least partially mounted between the two side arms 207 of the micro-actuator 205.

The slider 203 is connected (e.g. bonded using epoxy dots 212) to the two ceramic beams 207 at points 206 proximate to the opening of the U-shaped frame. The frame 297 is shaped like a hollow rectangular structure for receiving the slider 203. The bottom of the frame 297 is attached to the suspension tongue region of the suspension. The slider 203 and the beams 207 are not directly connected to the suspension and thus may move freely with respect to the suspension.

When an actuating power is applied through the suspension traces 210, the PZT pieces on the ceramic beams 207 will expand and/or contract, causing the two ceramic beams 207 to bend in a common lateral direction. The bending causes a shear deformation of the frame 297, whereby its shape resembles a parallelogram. The slider 203 undergoes a lateral translation because it is attached to the moving side(s) of the parallelogram. Thus, a fine head position adjustment can be attained.

Unfortunately, translation of the slider 203 may generate a lateral inertial force that causes a suspension vibration resonance that has the same or similar resonance effect as shaking the suspension base plate. This will affect the dynamic performance of the HGA and reduce the servo bandwidth and the capacity of the HDD. In particular, referring to FIG. 3a, which is a typical prior art micro-actuator design, the U-shaped micro-actuator 205 is at least partially mounted on the suspension tongue. When the micro-actuator 205 is operated, the two side arms 307a, 307b will bend outwardly. When one side arm 307a bends along the direction 300a, it will generate a reaction force Fa in the bottom arm which is mounted on the suspension tongue. This reaction force Fa will transfer to the suspension and generate a vibration which have the same or similar effect as shaking the suspension base plate. Similarly, when the other side arm 307b bends along the direction 300b, it will generate a reaction force Fb in the bottom arm and this reaction force Fb also will transfer to the suspension and generate a vibration which have the same or similar effect as shaking the suspension base plate.

As shown in FIG. 3b, which shows the resonance characteristics of certain prior art micro-actuator designs, line 301 represents a resonance curve when the suspension base plate is shaken, and line 302 represents a resonance curve when the micro-actuator 205 of FIG. 3a is excited. As can be appreciated from FIG. 3b, under a frequency of 20K, there are several large peaks and valleys in the suspension frequency response, which indicates poor resonance characteristics.

Thus it will be appreciated that there is a need in the art for an improved micro-actuator, HGA, and/or disk drive device, and/or methods of making the same.

### SUMMARY OF THE INVENTION

One aspect of certain example embodiments described herein relates to a micro-actuator having a flexible side arm capable of causing displacement.

Another aspect of certain example embodiments described herein relates to a micro-actuator having a reduced and/or eliminated gap between the slider and the suspension tongue.

Yet another aspect of certain example embodiments described herein relates to micro-actuators having better resonance and servo performance, reduced difficulties associated with the slider/micro-actuator mounting process, and/or better shock performance.

According to certain example embodiments, a micro-actuator is provided. A substantially U-shaped frame may include a cavity capable of receiving a slider. The frame may include two side arms and a bottom support arm at least partially defining the cavity. Each side arm may have a PZT element mounted on an outer surface thereof facing away from the cavity. Each side arm may include a lower portion proximate to the bottom support arm and an upper portion disposed at an end opposing the bottom support arm, with the lower portion and the upper portion being at least partially separated by a gap.

According to certain other example embodiments, a head gimbal assembly is provided. A suspension may be configured to support on a tongue region thereof a micro-actuator and a slider. The suspension may comprise a hinge coupled with a load beam and a base plate. The micro-actuator may comprise a substantially U-shaped frame including a cavity capable of receiving a slider. The frame may include two side arms and a bottom support arm at least partially defining the cavity. Each side arm may have a PZT element mounted on an outer surface thereof facing away from the cavity. Each side arm may include a lower portion proximate to the bottom support arm and an upper portion disposed at an end opposing the bottom support arm, with the lower portion and the upper portion being at least partially separated by a gap.

According to still other example embodiments, a disk drive device is provided. A head gimbal assembly may carry a slider and a micro-actuator. A drive arm may be connected to the head gimbal assembly. A disk and a spindle motor operable to spin the disk also may be provided. The micro-actuator may comprise a substantially U-shaped frame including a cavity capable of receiving a slider. The frame may include two side arms and a bottom support arm at least partially defining the cavity. Each side arm may have a PZT element mounted on an outer surface thereof facing away from the cavity. Each side arm may include a lower portion proximate to the bottom support arm and an upper portion disposed at an end opposing the bottom support arm, with the lower portion and the upper portion being at least partially separated by a gap.

Yet further example embodiments provide a method of making a micro-actuator. Two side portions may be connected around one or more center support portions, and a PZT element may be connected to an outer side of each side portion to form a large structure. The large structure may be exposed to high-temperature firing. The large structure may be cut into at least one micro-actuator. The at least one micro-actuator may comprise a substantially U-shaped frame including a cavity capable of receiving a slider, with the frame including two side arms and a bottom support arm at least partially defining the cavity. Each side arm may include a lower portion proximate to the bottom support arm and an upper portion disposed at an end opposing the bottom support arm, the lower portion and the upper portion being at least partially separated by a gap.

In certain non-limiting example embodiments, the gap of each side arm may completely separate the upper portion and the lower portion of corresponding side arm. Also, the micro-actuator of certain example embodiments may further include a protrusion at least partially defining one or more recessions located between the protrusion and the lower portions of each side arm. In addition to the bottom support arm, an upper support arm may be provided in certain example embodiments, with both the bottom support arm and the upper support arm being substantially cradle-shaped such that the slider is capable of being located within the cradle.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is a partial perspective view of a conventional disk drive unit;

FIG. 2a is a partial perspective view of an HGA having a conventionally designed micro-actuator;

FIG. 2b is a partial perspective view of the tongue region of the HGA of FIG. 2a;

FIG. 2c illustrates how a slider and micro-actuator conventionally are mounted to each other;

FIG. 3a is a typical prior art micro-actuator design;

FIG. 3b shows the resonance characteristics of certain prior art micro-actuator designs;

FIG. 4a is a partial perspective view of an HGA, in accordance with an example embodiment;

FIG. 4b is a detailed partial perspective view of the tongue region of the HGA of FIG. 4a, in accordance with an example embodiment;

FIG. 4c is an enlarged view of the micro-actuator of FIGS. 4a and 4b, in accordance with an example embodiment;

FIG. 4d is a side view in the tongue region of an HGA, in accordance with an example embodiment;

FIG. 5 is a detailed partial perspective view of the tongue region of an illustrative HGA that helps to demonstrate the operation of certain example embodiments;

FIG. 6 is a partially exploded view of the tongue region of the HGA of FIG. 4a, in accordance with an example embodiment;

FIGS. 7a and 7b show techniques for driving micro-actuators, in accordance with an example embodiment;

FIG. 7c shows the initial status when no voltage is driving the micro-actuator;

FIG. 7d shows the rotation of the micro-actuator and the slider displacement when a voltage is applied;

FIG. 8a shows resonance testing data for certain example embodiments;

FIG. 8b shows related HGA resonance phase data for certain example embodiments;

FIGS. 9a-d structurally show an illustrative process for creating micro-actuators according to certain example embodiments;

FIG. 9e is a flowchart of an illustrative process for creating micro-actuators, in accordance with an example embodiment;

FIG. 10 is an enlarged view of another micro-actuator structure, in accordance with an example embodiment; and,

FIG. 11 is a perspective view of an assembled hard disk drive, in accordance with an example embodiment.

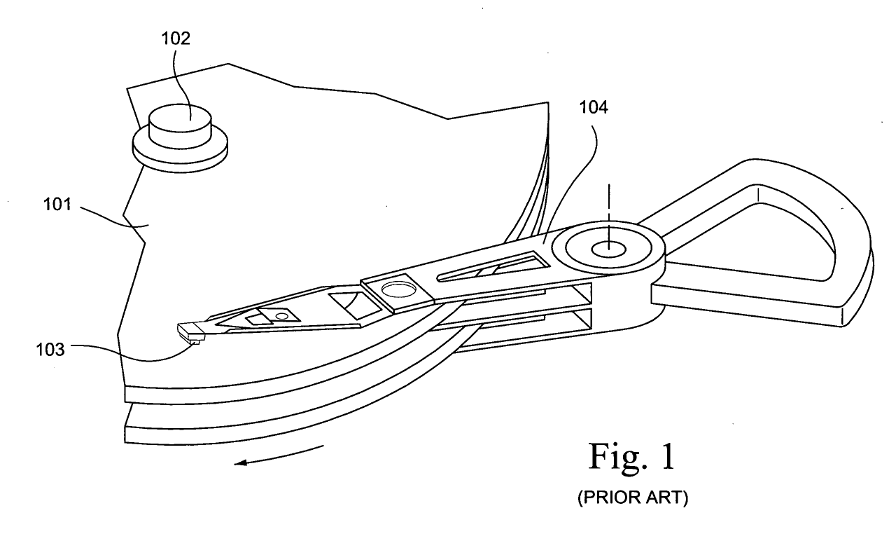

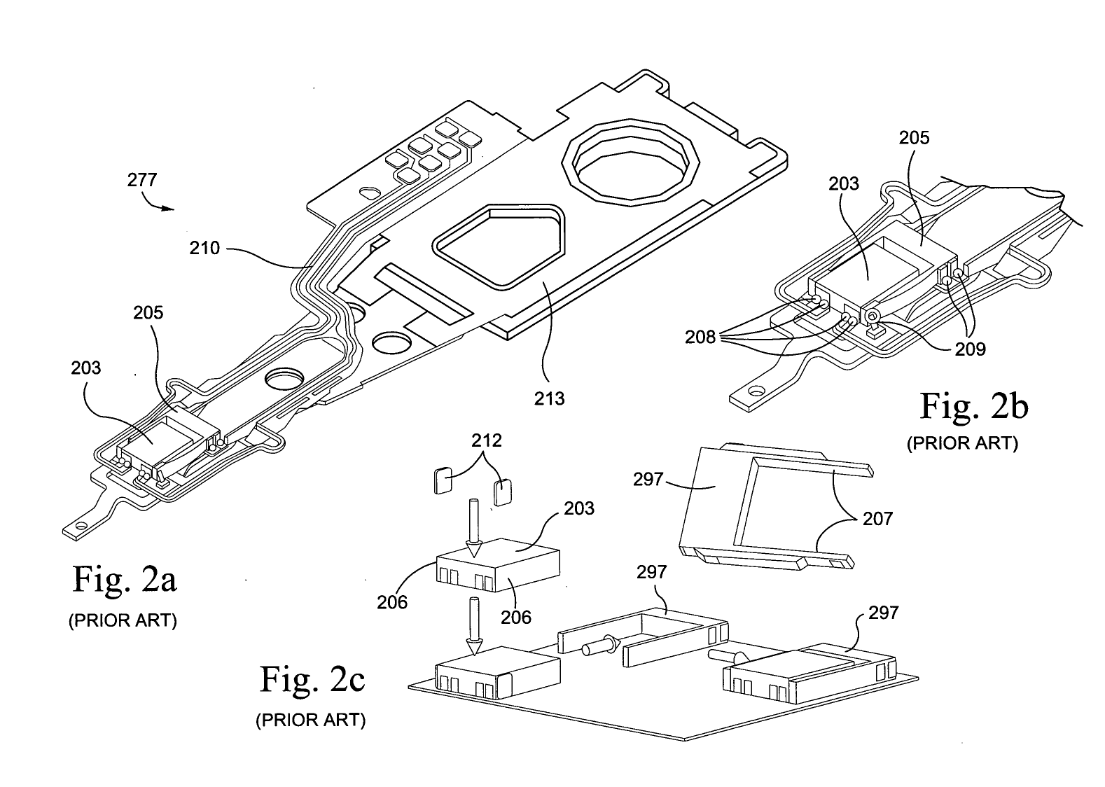

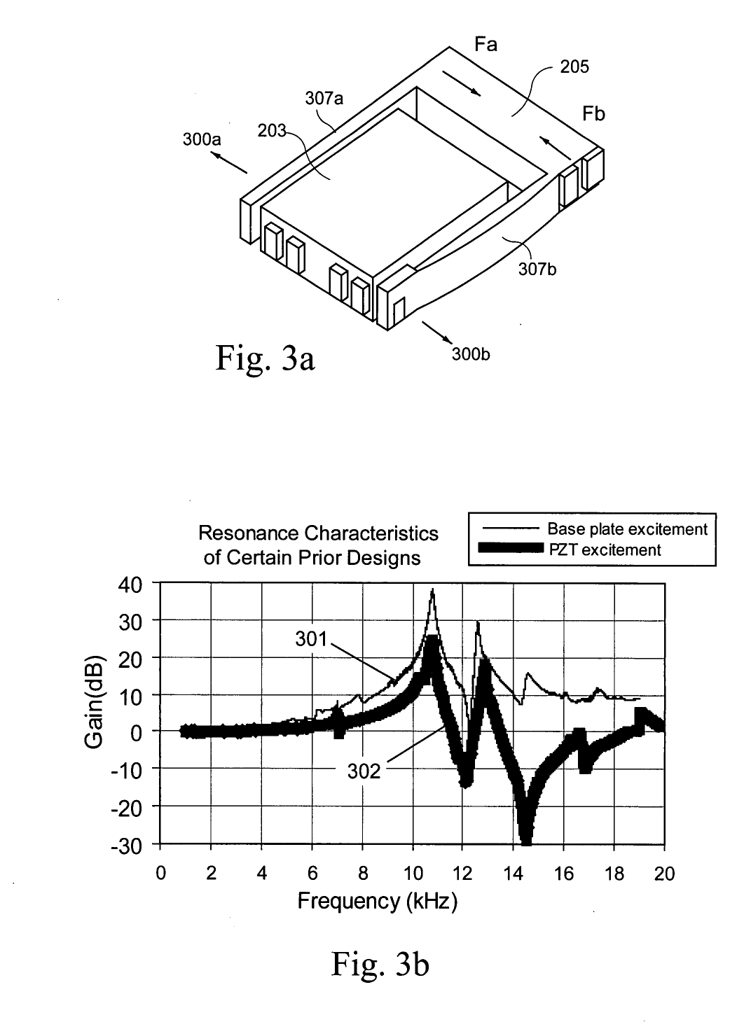

### DETAILED DESCRIPTION OF ILLUSTRATED EMBODIMENTS

Certain example embodiments disclosed herein relate to micro-actuators, HGAs, and disk drive devices including a micro-actuator having at least one flexible side arm and/or having a reduced (or in certain example embodiments, eliminated) gap between the slider and the suspension. Certain example embodiments disclosed herein may help to provide better resonance and servo performance, reduce the difficulties associated with the slider/micro-actuator mounting process, and/or provide better shock performance. For example, current micro-actuators are typically substantially U-shaped and have a parallel gap between the micro-actuator and the suspension, whereas the micro-actuators of certain example embodiments have a space in at least one side arm of the U-shaped frame and have a reduced gap between the slider and the suspension. Certain example embodiments are well-suited for high RPM disk drive devices, although they may be implemented in any type of disk drive device.

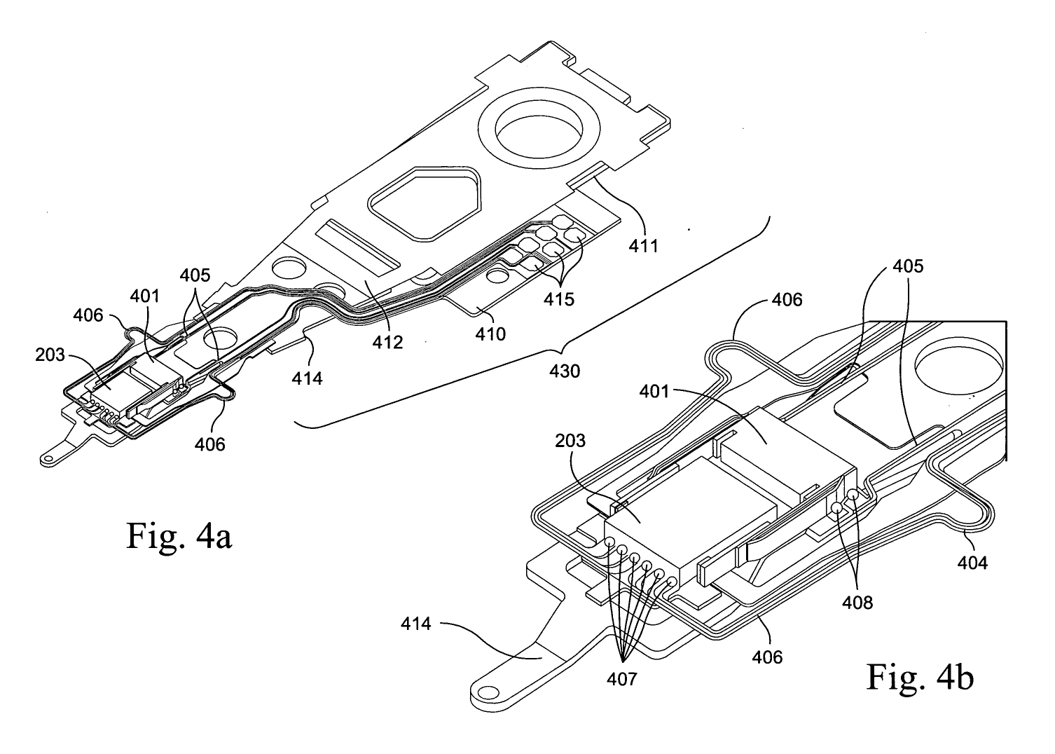

FIG. 4a is a partial perspective view of an HGA, in accordance with an example embodiment. A suspension 430 supports a micro-actuator 401 having an associated slider 203. The suspension 430 comprises a base plate 411, a hinge 412, a flexure 410, and a load beam 414. The outer traces 406 in the flexure 410 operably couple the read/write head of the slider 203 and the pads 415. The inner traces 405 in the flexure 410 operably couple the micro-actuator 401 with the pads 415. The pads 415 are operably coupled to the control system of the HDD.

FIG. 4b is a detailed partial perspective view of the tongue region of the HGA of FIG. 4a, in accordance with an example embodiment. The micro-actuator 401 is mounted on the suspension tongue region, and a slider 203 is at least partially mounted to the micro-actuator 401. There are multiple connection balls 407 (e.g. 6 balls as shown in FIG. 4b, although the present invention is not limited to any particular number of connections and/or connection balls) operably coupling the slider 203 to the suspension traces 406. There are two curves 404 in the outer traces 406. These curves help to release stresses related to the stiffness of the outer traces 406 during the operation of the micro-actuator 401, thus helping to make the micro-actuator 401 work more smoothly. Additional connection balls 408 operably couple the micro-actuator 401 to the suspension traces 405.

FIG. 4c is an enlarged view of the micro-actuator 401 of FIGS. 4a and 4b, in accordance with an example embodiment. The micro-actuator 401 comprises a bottom support 430 and two segmented side arms. There are two PZT elements 435 located on the outer surfaces of the two side arms. Each segmented side arm comprises a lower portion 432 connected to the bottom support 430 of the micro-actuator 401, as well as an upper portion 433 connected to the PZT element 435. That is, there is a space or gap 431 in the side arms between the upper portions 433 and the lower portions 432. As also can be appreciated from FIG. 4c, there are two recessions 436 formed at opposing sides of the bottom support 430 proximate to the slot for receiving the slider 203. Alternatively or in addition, there is a protrusion 437 extending from the bottom support 430 forming gaps 436 between the protrusion 436 and the lower portions 432 of the side arms. There are also two pads 320b at the ends of the outer surface of the two PZT elements 435 for driving (e.g., electrically driving) the two PZT elements 435. It has been determined that this arrangement and similar arrangements help to maintain the flexibility of the two side arms while also making it better suited for slider displacement.

FIG. 4d is a side view in the tongue region of an HGA, in accordance with an example embodiment. FIG. 4d shows a dimple 417 formed on the suspension load beam 414, which supports the tongue 418 of the suspension flexure. The dimple 417 may support the center of the back side of the suspension tongue 418. The support point also may offset the center of the back side of the suspension tongue 418. The slider 203 is supported by the two side arms of the micro-actuator 401. The bottom support 430 of the micro-actuator 401 is mounted on the suspension tongue 418. An epoxy plot 420 is located on the center region of the suspension tongue 418 which may be used to mount the slider to the suspension tongue 418, A space 421 is located approximately in the center of the slider, at least partially separating the slider from the suspension tongue 418. The space 421 is at least partially defined by the epoxy plot 420 and the bottom arm mounting area. This arrangement allows the slider to rotate substantially freely when the micro-actuator 401 is operated.

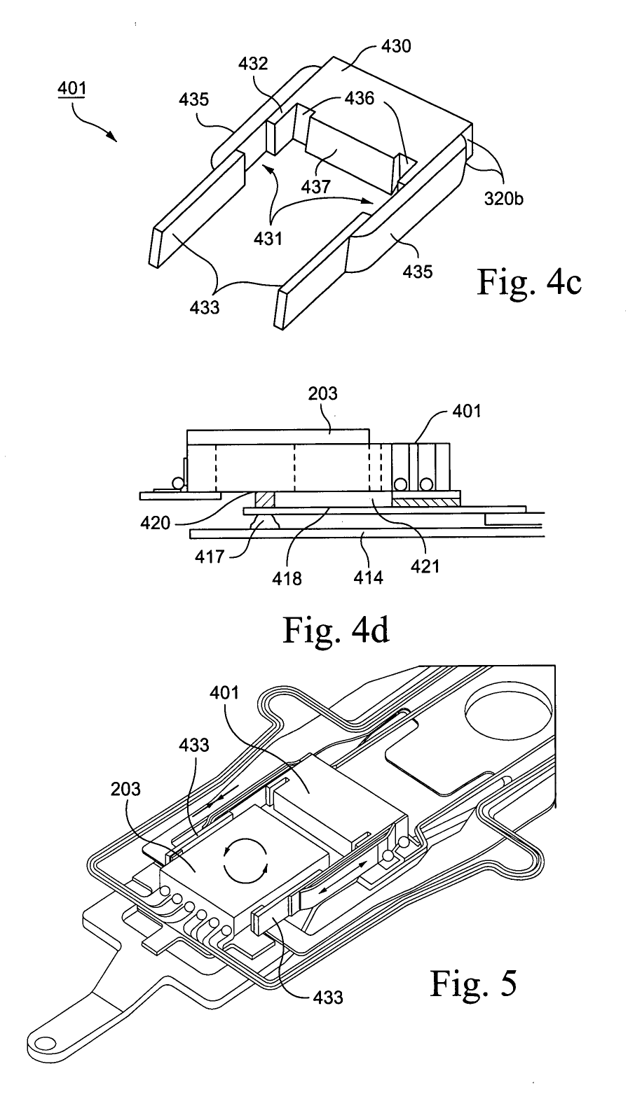

FIG. 5 is a detailed partial perspective view of the tongue region of an illustrative HGA that helps to demonstrate the operation of certain example embodiments. In particular, when the micro-actuator 401 is operated, one of the side arms shrinks while the other side arm expands because of the movement generated by one or both of the PZT elements. Because the back center of the slider is fixed and the top portions of the two side arms of the micro-actuator 401 are mounted with the two side surfaces of the slider proximate to its tail edge, the push/pull movement will cause displacement and thus slider rotation.

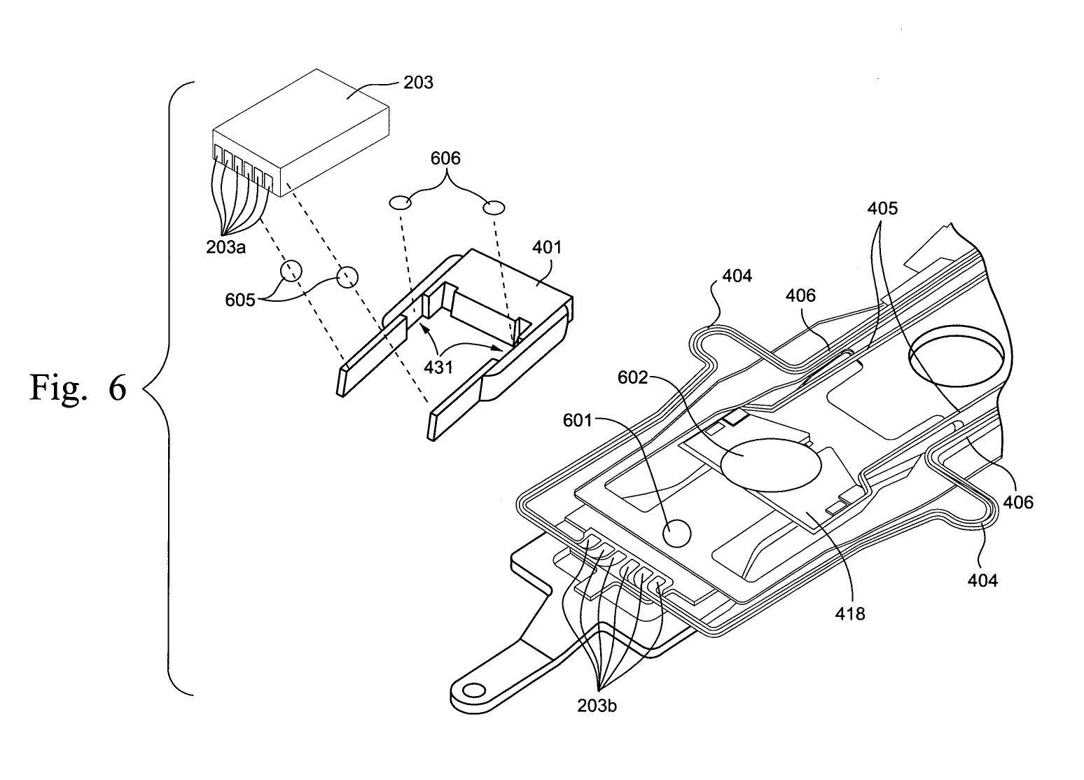

FIG. 6 is a partially exploded view of the tongue region of the HGA of FIG. 4a, in accordance with an example embodiment. There are two epoxy plots 606 inserted into the spaces 431 of the two side arms of the micro-actuator 401. This helps to keep the two arms flexible but also rigid. This illustrative structure helps to ensure that the micro-actuator has at least one flexible support arm which facilitates achieving a large displacement characteristics. This illustrative structure also helps to improve the shock performance of the micro-actuator because of the stiffness of the two side arms. The epoxy plot 602 is applied to the suspension tongue, and the micro-actuator 401 is then mounted to the suspension tongue via the epoxy plot 602. The epoxy plot 601 is applied to the center of the suspension tongue. The slider is inserted into the micro-actuator, and the slider is mounted to the suspension tongue. The epoxy plots 605 may be used for mounting the slider to the micro-actuator. In another example embodiment, the two epoxy plots 606 may be inserted into the spaces 431 of the two side arms of the micro-actuator 401 first, then the two epoxy plots 605 may be mounted to the slider with the two side arms of the micro-actuator, with the epoxy 602 and epoxy plot 601 finally applied to the suspension tongue before the micro-actuator and slider are mounted to the suspension. It will be appreciated that these and/or other manufacturing processes may be used to achieve the same or similar HGA structure.

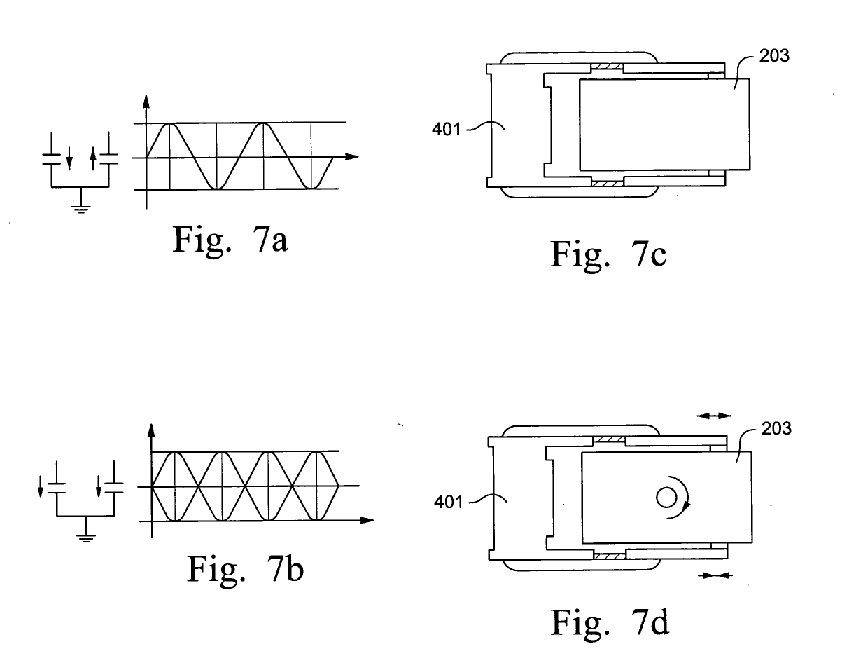

FIGS. 7a and 7b show techniques for driving micro-actuators, in accordance with an example embodiment. For example, a sine voltage may be applied to the micro-actuator having two side arms which have opposed polarization directions. One of the side arms of the micro-actuator will shrink, but the other will extend. Because the slider is at least partially mounted to the two side arms of the micro-actuator and also at least partially mounted to the suspension tongue, a torque will be generated, causing slider to rotate against the epoxy plot 601 and generate a displacement. Because the epoxy plot 601 is located approximately in the center of the slider's back side, the slider will rotate approximately around its center. In FIG. 7a, a single wave is input, whereas when two sine waves having opposite phases are input to the two PZT elements of the micro-actuator having opposite polarization directions as shown in FIG. 7b, one side arm of the micro-actuator will shrink but the other arm will extend, similarly, and a torque will be generated causing the slider to rotate around its center. FIG. 7c shows the initial status when no voltage is driving the micro-actuator, and FIG. 7d shows the rotation of the micro-actuator and the slider displacement when a voltage is applied.

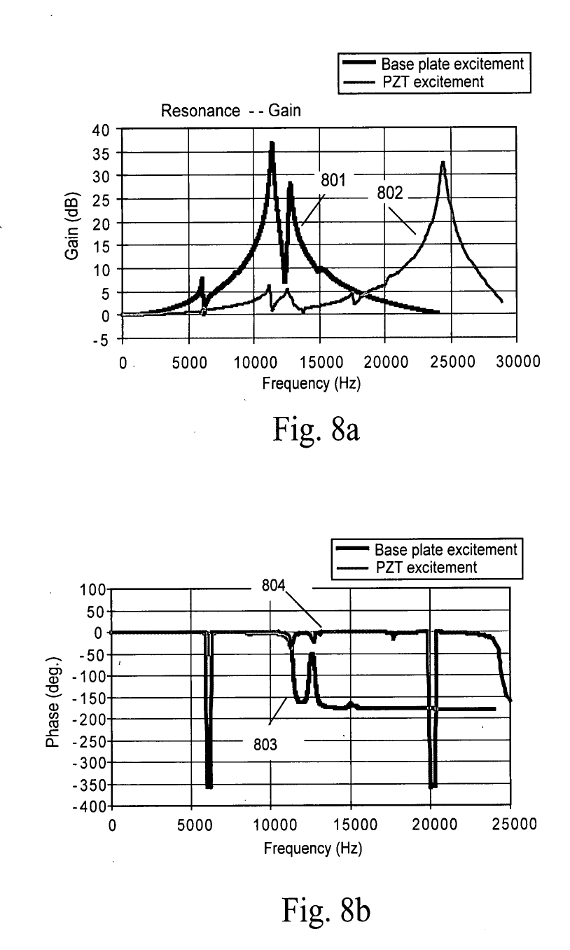

FIG. 8a shows resonance testing data for certain example embodiments. The curve 801 shows an HGA resonance gain when the suspension base plate is excited, and the curve 802 shows an HGA resonance gain when the PZT micro-actuator is excited. Because the micro-actuator moves rotationally, there tends to be a reduced amount of stress transferred to the suspension. Accordingly, there tends to be a reduced amount of suspension resonance when the micro-actuator is operated. Similarly, FIG. 8b shows related HGA resonance phase data for certain example embodiments. The curve 803 shows Phase vs. Frequency data when the base place is excited, and the curve 804 shows Phase vs. Frequency data when the PZT micro-actuator is excited.

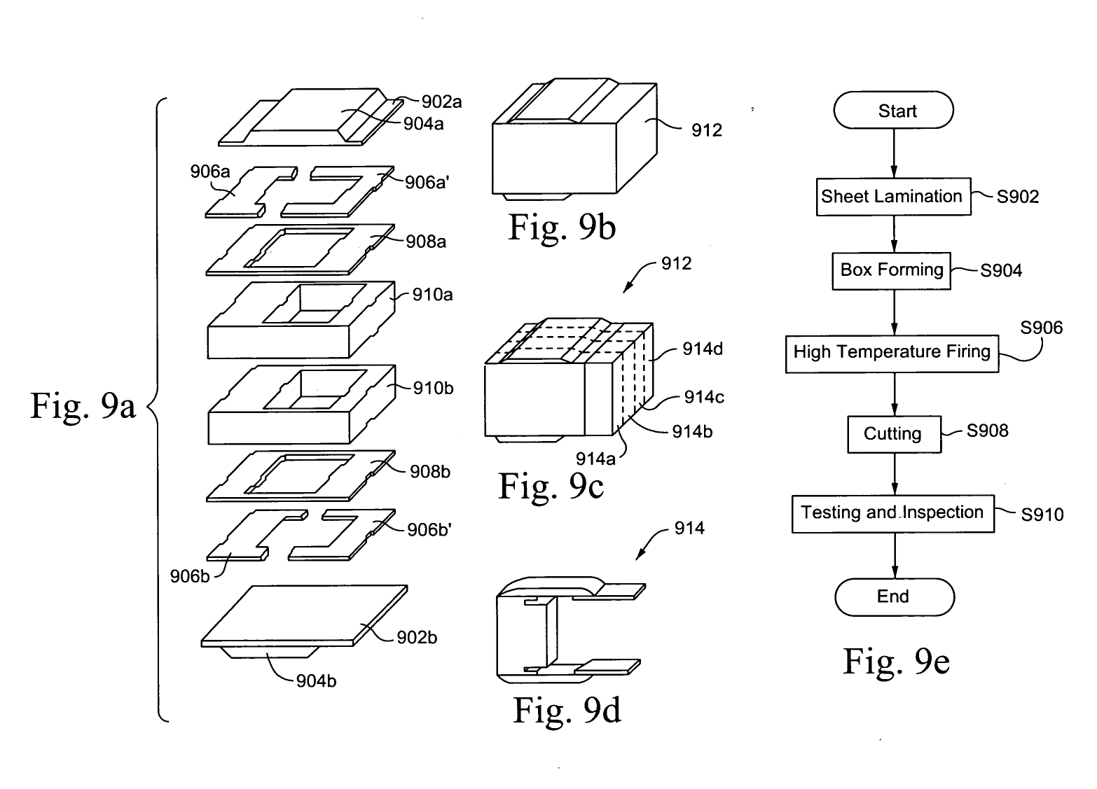

FIGS. 9a-d structurally show an illustrative process for creating micro-actuators, which may be formed from a ceramic base material (e.g., Zirconia or Silicon) according to certain example embodiments. In particular, FIG. 9a is a partially exploded view illustrating one method of manufacturing an illustrative micro-actuator, in accordance with an example embodiment. PZT layers 904a-b may be connected (e.g., laminated) to a top and bottom sheet 902a-b, respectively. The upper and lower side arm portions 906a-b and 906a′-b′ (which may be formed from a ceramic) may be connected to the inner portions (which may be formed from a ceramic) of the top and bottom sheet 902a-b, respectively. Spacer sheets 908a-b (which also may be formed from a ceramic) may be provided between the upper and lower side arm portions 906a-b and 906a′-b′ and the main body portion(s) 910a-b. It will be appreciated that the various components of this structure may be members formed by the connection of one or more support sheets (e.g., the top or bottom sheet 902a-b, the upper and lower side arm portions 906a-b or 906a′-b′, the spacer sheet 908a-b, the main body portion 910a-b, each can be separated into two or more layer sheets), or alternatively may be provided as a single sheet, already formed with the desired dimensions. Of course, the locations of the side arm portions, spacer portions, main body portions, etc. may be varied in certain example embodiments (e.g., the sheet laminating method may vary in production to produce the final micro-actuator structure).

After the connection (e.g., lamination) process is completed, the structure may be subjected to a high-temperature firing. The large U-shaped box structure of FIG. 9b may be cut (e.g., along the dashed lines of FIG. 9c) to form multiple, single micro-actuator units 914a-d of the type 914 shown in FIG. 9d. It will be appreciated that the dashed lines are provided by way of example and without limitation. For example, a single large U-shaped box structure may be used to produce more or fewer cuts in certain example embodiments. Also, it will be appreciated that the desired depth of the micro-actuators may vary.

FIG. 9e is a flowchart of an illustrative process for creating micro-actuators, in accordance with an example embodiment. Multiple sheets may be laminated in step S902 (e.g., as shown in FIG. 9a), thus forming a “box” in step S904 (e.g., as shown in FIG. 9b). The laminated structure may be subjected to a high-temperature firing in step S706. The pieces may be cut (e.g., along the lines shown in FIG. 9c) to produce multiple, single micro-actuators (e.g., of the type shown in FIG. 9d) in step S908. The single micro-actuators may be subjected to testing and inspection in step S910. Optionally, the single micro-actuators may be cleaned. Finally, the single micro-actuators may be ready for use.

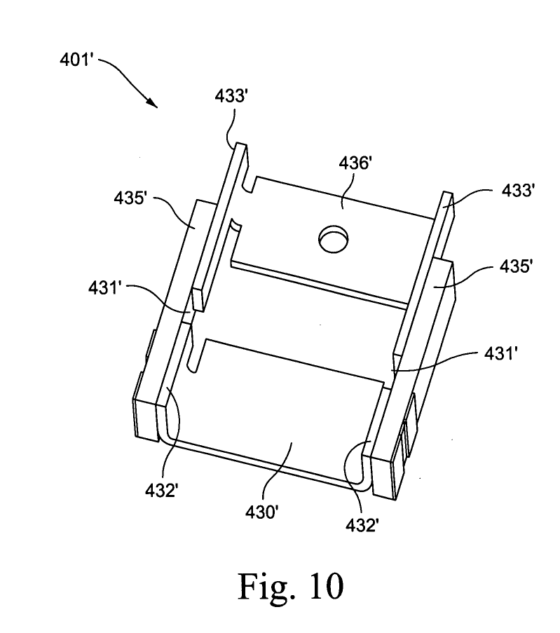

FIG. 10 is an enlarged view of another micro-actuator 401′ structure, in accordance with an example embodiment. The micro-actuator 401′ comprises a frame (e.g., a metal frame) and two PZT elements 435′. The metal frame includes a top support and a bottom support 430′. There are two side arms, each being coupled to one of the two PZT elements 435′. The two side arms comprise a lower portion 432′ connected to the bottom support 430′ and an upper portion 433′ connected to the upper support 436′. In certain example embodiments, the upper portions 433′ and upper support 436′, as well as the lower portions 432′ and lower support 430′ may be thought of as forming a cradle for accommodating the slider. Each side arm has a space 431′ formed therein. This space helps to ensure flexibility for the micro-actuator 401′ and provides for advantageous slider displacement.

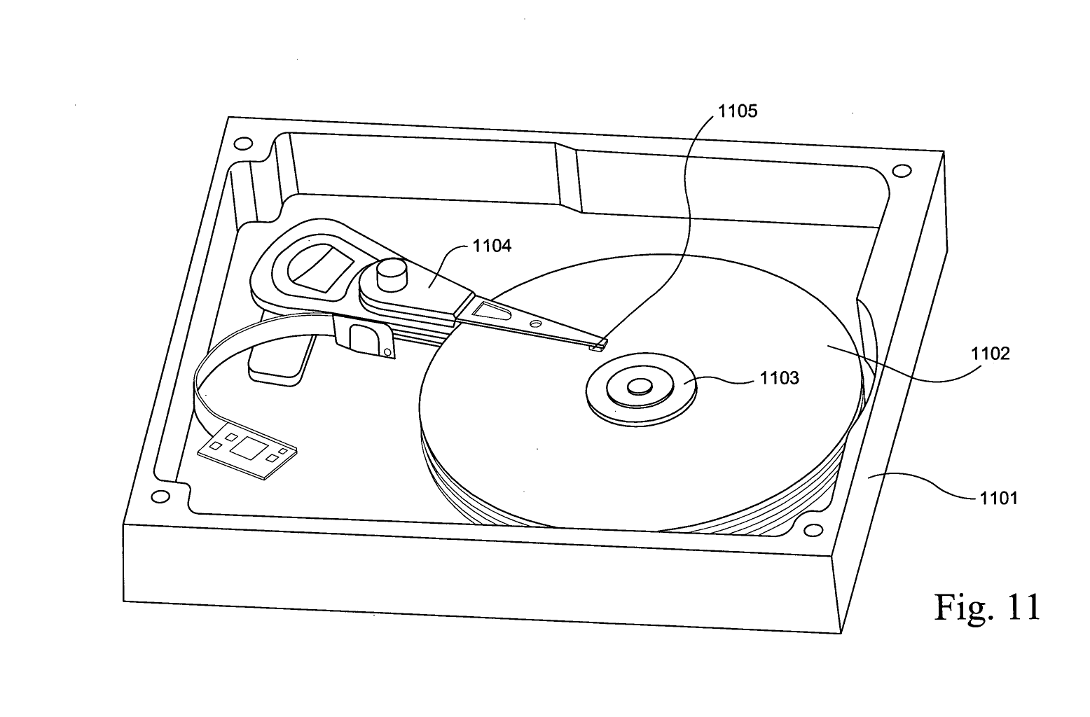

FIG. 11 is a perspective view of an assembled hard disk drive, in accordance with an example embodiment. In brief, the HDD includes a frame 1101. One or more disks 1102 are spun by a spindle motor 1203. A VCM 1104 controls the slider 1105 that flies over the disk 1102. The slider 1105 may be inserted into a micro-actuator frame (not shown), designed in accordance with any example embodiment disclosed herein. One of ordinary skill in the art will clearly understand the operation of the HDD of FIG. 11, and further details are omitted to avoid confusion.

It will be appreciated that the micro-actuator frames described herein may be formed from any suitable material. By way of example and without limitation, the micro-actuator frames may be formed from a metal, a ceramic, or any other suitable material. Additionally, any suitable type of PZT element may be used, such as, for example, a ceramic PZT, a thin-film PZT, or a PMN-Pt PZT. Moreover, the PZT element may be a single layer or a multi-layer PZT element. Finally, it will be appreciated that in certain example embodiments, the gaps formed in the side arms may completely separate the upper and lower portions of each side arm. However, in certain other example embodiments, the gaps may consist of one or more protrusions and/or recessions to define one or more gaps between one or more portions of each side arm.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A micro-actuator, comprising:
a substantially U-shaped frame including a cavity capable of receiving a slider, the frame including two side arms and a bottom support arm at least partially defining the cavity;
wherein each side arm has a PZT element mounted on an outer surface thereof facing away from the cavity; and,
wherein each side arm includes a lower portion proximate to the bottom support arm and an upper portion disposed at an end opposing the bottom support arm, the lower portion and the upper portion being at least partially separated by a gap.

2. The micro-actuator of claim 1, wherein the gap of each side arm completely separates the upper portion and the lower portion of each corresponding side arm.

3. The micro-actuator of claim 1, further comprising a protrusion protruding from the bottom support arm into the cavity.

4. The micro-actuator of claim 3, wherein the protrusion at least partially defines two recessions, each recession being located between the protrusion and the lower portions of each side arm.

5. The micro-actuator of claim 1, wherein the micro-actuator is suitable for being disposed on a suspension tongue, and wherein a slider inserted into the cavity is situated so that a gap between the slider and the suspension tongue is at least partially filled in.

6. The micro-actuator of claim 1, further comprising an upper support arm connecting the upper portions of each side arm.

7. The micro-actuator of claim 6, wherein the bottom support arm and the upper support arm are substantially cradle-shaped such that the slider is capable of being located within the cradle.

8. A head gimbal assembly, comprising:
a suspension configured to support on a tongue region thereof a micro-actuator and a slider, the suspension comprising a hinge coupled with a load beam and a base plate;
wherein the micro-actuator comprises a substantially U-shaped frame including a cavity capable of receiving the slider, the frame including two side arms and a bottom support arm at least partially defining the cavity;
wherein each side arm has a PZT element mounted on an outer surface thereof facing away from the cavity; and,
wherein each side arm includes a lower portion proximate to the bottom support arm and an upper portion disposed at an end opposing the bottom support arm, the lower portion and the upper portion being at least partially separated by a gap.

9. The head gimbal assembly of claim 8, wherein the gap of each side arm completely separates the upper portion and the lower portion of each corresponding side arm.

10. The head gimbal assembly of claim 8, further comprising a protrusion protruding from the bottom support arm into the cavity.

11. The head gimbal assembly of claim 10, wherein the protrusion at least partially defines two recessions, each recession being located between the protrusion and the lower portions of each side arm.

12. The head gimbal assembly of claim 8, wherein a slider inserted into the cavity is situated so that a gap between the slider and the suspension tongue is at least partially filled in.

13. The head gimbal assembly of claim 8, further comprising an upper support arm connecting the upper portions of each side arm.

14. The head gimbal assembly of claim 13, wherein the bottom support arm and the upper support arm are substantially cradle-shaped such that the slider is capable of being located within the cradle.

15. A disk drive device, comprising:
a head gimbal assembly carrying a slider and a micro-actuator;
a drive arm connected to the head gimbal assembly;
a disk; and,
a spindle motor operable to spin the disk,
wherein the micro-actuator comprises a substantially U-shaped frame including a cavity capable of receiving a slider, the frame including two side arms and a bottom support arm at least partially defining the cavity;
wherein each side arm has a PZT element mounted on an outer surface thereof facing away from the cavity; and,
wherein each side arm includes a lower portion proximate to the bottom support arm and an upper portion disposed at an end opposing the bottom support arm, the lower portion and the upper portion being at least partially separated by a gap.

16. The disk drive device of claim 15, wherein for gap of each side arm completely separates the upper portion and the lower portion of each corresponding side arm.

17. The disk drive device of claim 15, further comprising a protrusion protruding from the bottom support arm into the cavity.

18. The disk drive device of claim 17, wherein the protrusion at least partially defines two recessions, each recession being located between the protrusion and the lower portions of each side arm.

19. The disk drive device of claim 15, wherein the micro-actuator is suitable for being disposed on a suspension tongue, and wherein a slider inserted into the cavity is situated so that a gap between the slider and the suspension tongue is at least partially filled in.

20. The disk drive device of claim 15, further comprising an upper support arm connecting the upper portions of each side arm.

21. The micro-actuator of claim 20, wherein the bottom support arm and the upper support arm are substantially cradle-shaped such that the slider is capable of being located within the cradle.

22. A method of making a micro-actuator, comprising:
connecting two side portions around one or more center support portions and connecting a PZT element to an outer side of each side portion to form a large structure;
exposing the large structure to high-temperature firing; and,
cutting the large structure into at least one micro-actuator,
wherein the at least one micro-actuator comprises a substantially U-shaped frame including a cavity capable of receiving a slider, the frame including two side arms and a bottom support arm at least partially defining the cavity,
wherein each side arm includes a lower portion proximate to the bottom support arm and an upper portion disposed at an end opposing the bottom support arm, the lower portion and the upper portion being at least partially separated by a gap.

23. The method of claim 22, further comprising disposing two spacer portions between the side portions and the center support portion.

24. The method of claim 22, further comprising at least partially mounting the at least one micro-actuator onto a head gimbal assembly.

25. The method of claim 24, further comprising installing the head gimbal assembly into a disk drive device.
